(19) United States
(12) Patent Application Publication
(10) Pub. No.: US 2004/0264876 A1
(43) Pub. Date: Dec. 30, 2004

(54) Optical connector

(76) Inventor: Joshua D. Posamentier, Oakland, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/611,559

(22) Filed: Jun. 30, 2003

(51) Int. Cl. G02B 6/36; G02B 6/38

(52) U.S. Cl. 385/78; 385/60

(57) ABSTRACT

A small form factor (SSF) pluggable optical connector may be subject to wear damage when plugged and unplugged. A press-fit metal or ceramic sleeve is placed inside of the female receptacle to prevent the male portion of the connector, including a fiber optic tip, from making direct contact with the inner wall of the receptacle. Thus, the connector may be strengthened resulting in a connector that is more resistant to wear and further may prevent worn debris from fouling the tip of the optical fiber.

### FIELD OF THE INVENTION

An embodiment of the present invention is directed to optical connectors and, more particularly, to robust optical connectors.

### BACKGROUND INFORMATION

With the proliferation of optical communication systems including deployment of fiber for local area networks for campus and building backbone systems, the use of small fiber optic connectors is becoming more prevalent. Connectors are key components for joining optical fibers at their ends for optical-optical applications as well as aligning terminal ends of fibers to optoelectrical interfaces for use in optical-electrical applications. The connectors are responsible for maintaining axial alignment of the fiber end at the fiber core while butting the end of the fiber at a particular lateral position. This may be a difficult task given the extremely small diameter of the fiber which may be on the order of nine or ten microns across. A precise connection is important for low insertion losses and a reliable connection.

There are many types of optical connectors available on the market today. For the past decade or so the fiber optic industry has been using what is known as the SC duplex fiber optic connector system as the optical fiber connector interface on the front of fiber optic transceivers. More recently, the so-called small form factor (SFF) pluggable connectors, including the LC connector, have been adopted as the standardized removable connector for optical transceivers.

Optical connectors are typically pluggable. That is, the male portion of the connector, which includes the fiber optic tip, is joined with the female portion of the connector. Depending on the application, the connector may be plugged once and then left alone, or may be repeatedly plugged and unplugged many times over its lifetime. While optical connectors are designed to be robust, the very nature of the small size of the fiber makes it vulnerable to wear damage. In particular, contamination such as that caused by dust or dirt deposits on the fiber tip can lead to serious insertion losses and may effect performance.

FIG. 1 shows a cut away view of a typical connector arrangement. The female portion of the connector, or receptacle 10, may be made of injection molded plastic. The male portion of the connector typically includes a glass or ceramic ferrule probe 12 that protects and provides a rigid support for an enclosed optical fiber 14. The probe 12 is sized to fit inside the receptacle 10 and maintain axial alignment of the optical fiber 14 within the receptacle 10. The opening of the receptacle 10 may include a beveled or rounded edge 16 to facilitate insertion. The probe 12 is generally cylindrical in shape and the leading probe tip 18 may have a sharp edge 20.

The probe 12 is typically made of a rigid material, such as glass or ceramic and may be polished flat and chamfered and so typically has sharp edges. Thus, when the probe 12 is inserted or removed from the receptacle 10 it tends to scrape against the inner surface of the receptacle 10 if it is not inserted straight. Insertion of the probe 12 at any angle may accelerate wear particularly considering that the receptacle 10 is typically made of a softer material such as molded plastic, and prone to wear. After repeated insertions, dust or debris 22 worn off the inner surface of the receptacle 10 may accumulate on over the tip of the fiber 14 and decrease the amount of light that may be transmitted to or from the fiber 14. Rounding or beveling the sharp edges 20 of the probe 12 may lessen the wear, but may not eliminate the debris 22 to a suitable degree.

### BRIEF DESCRIPTION OF THE DRAWINGS

FIG. 1 is a cut away view of a typical optical connector;

FIG. 2A is a view of the connector probe tip;

FIG. 2B is a view of the connector receptacle having a sleeved insert according to an embodiment of the invention;

FIG. 3 is a cut away side view of the optical connector according to an embodiment of the invention; and

FIG. 4 is a cross sectional view taken along line 1-1′ of FIG. 3 looking into the receptacle portion of the connector according to an embodiment.

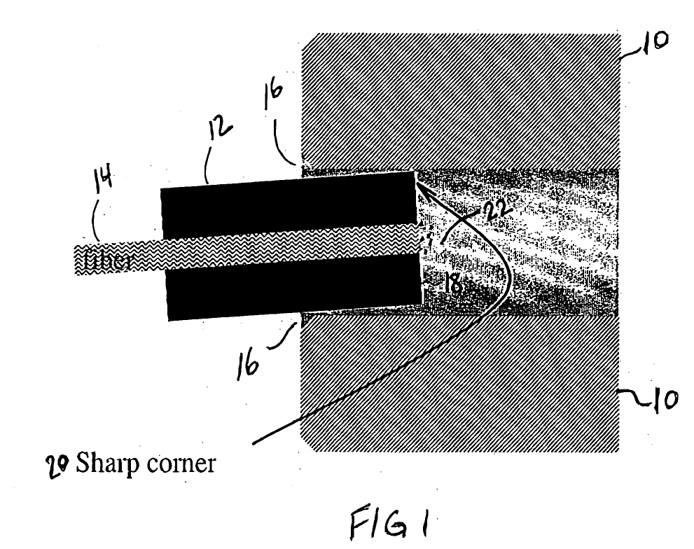

### DETAILED DESCRIPTION

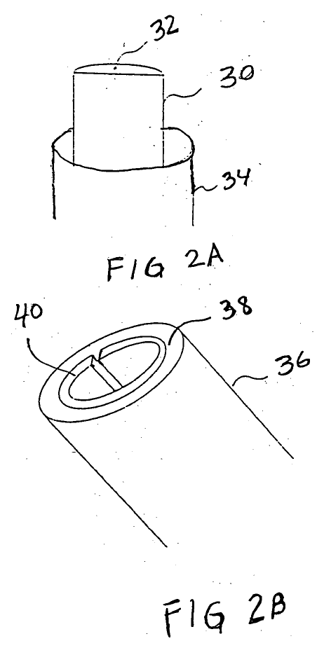

Referring now to FIG. 2A there is shown a probe tip which includes a ceramic ferrule 30 encasing an optical fiber 32. The probe tip may also include an outer mating portion 34 that aids in securing the probe tip within the receptacle 36 shown in FIG. 2B. The receptacle 36 comprises an opening 38 sized slightly larger than the diameter of the probe 30. The probe 30 may be made of glass or ceramic or similarly suited rigid material. The receptacle 36 may be made from plastic, such as, for example, from injection molded plastic or injection molded polyetherimide (PEI). Further, a protective sleeve 40 is fitted into the receptacle opening 38. The protective sleeve 40 and may comprise a substantially cylindrical shape having an inner diameter sized to accept the probe 30. The protective sleeve 40 may have a C-shaped cross section and be press fitted into the opening 38. The C-shape cross section tends to provide the sleeve 40 with a resilient or spring property which may hold the insert in place within the receptacle opening 38.

FIG. 3A is a cut away side view of the optical connector illustrating the probe 30 connected to the receptacle 36. As shown, the protective sleeve 40 lines the lines the inner wall of the opening 38 and protects the inner wall of the receptacle from damage that may otherwise be caused by insertion of the probe 30. The protective sleeve 40 comprises a material resilient to wear and may be a ceramic or a metal such as brass.

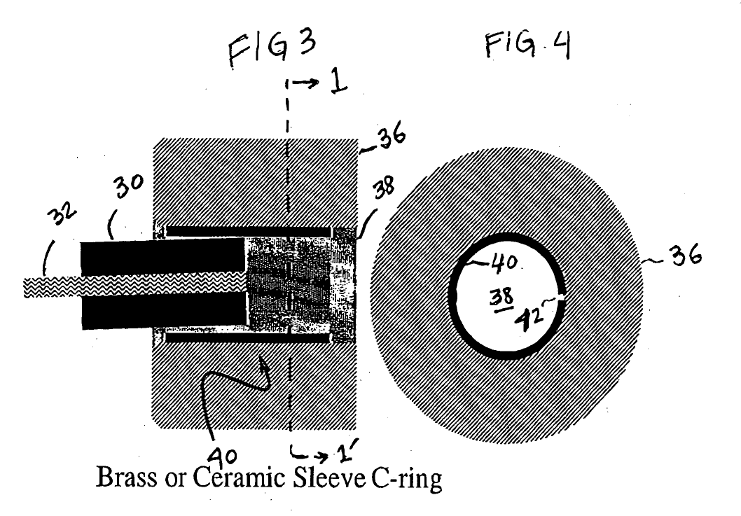

FIG. 4 is a cross-sectional view taken along line 1-1′ of FIG. 3 showing the C-shaped sleeve 40 fitted in the inner wall of the receptacle 36 within the opening 38. A gap 42 along a side of the sleeve 40 allows the sleeve to be compressed to be press fitted into the opening without damaging the inner wall of the receptacle 36. Once the sleeve 40 is inserted inside of the opening 38 it may expand to make a secure fit within the opening 38.

By placing a press-fit metal or ceramic sleeve 40 the inside of the female receptacle 36, the connector may be strengthened or fortified resulting in a connector that is more resistant to wear since the sleeve 40 may protect the inner wall of the receptacle from direct contact with the probe 12. This may be a more cost effective solution than fabricating the entire connector out of a more rugged material. Embodiments also provide for repeated precision insertions as the connector should degrade little over time, whereas plastic components may be permanently damaged or eventually deformed. According to an example embodiment, the protective sleeve 40 strengthens precision molded soft plastic part using a more durable metal or ceramic insert instead of making the entire connector out of metal or ceramic. Thus, the precision of the plastic device may be preserved while providing the stability of metal or ceramic over a variety of operating conditions.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An optical connector, comprising:
a probe comprising a rigid support encasing an optical fiber
a receptacle formed from a material softer than said rigid support, said receptacle comprising an opening to receive said probe; and
a sleeve lining an inner wall of said opening.

2. The optical connector as recited in claim 1 wherein said sleeve is substantially cylindrical in shape and has a C-shaped cross section.

3. The optical connector as recited in claim 2 wherein said sleeve comprises one of a ceramic and a metal.

4. The optical connector as recited in claim 2 wherein said sleeve comprises brass.

5. The optical connector as recited in claim 3 wherein said connector comprises one of an SC connector and an LC connector.

6. The optical connector as recited in claim 5 wherein said sleeve is a press-fit sleeve.

7. The optical connector as recited in claim 3 wherein said receptacle comprises injection molded plastic.

8. The optical connector as recited in claim 7 wherein said injection molded plastic comprises polyetherimide (PEI).

9. A method for fortifying an optical connector, comprising:
encasing a fiber optic within a rigid probe;
forming a receptacle with a plastic having an opening to receive said rigid probe; and
fitting a sleeve within said opening to protect said plastic from said rigid probe.

10. The method as recited in claim 10 further comprising:
forming said sleeve having a substantially cylindrical shape and having a C-shaped cross section with a gap along one side.

11. The method as recited in claim 10 wherein said fitting comprises:
compressing said sleeve to close said gap; and
pressing said sleeve into said opening.

12. The method as recited in claim 11 wherein said sleeve comprises one of a metal and a ceramic.

13. The method as recited in claim 11 wherein said sleeve comprises brass.

14. The method as recited in claim 11 further comprising:
forming said receptacle from injection molded plastic.

15. The method as recited in claim 14 wherein said plastic comprises polyetherimide (PEI).

16. A small form factor (SFF) pluggable connector for an optical system, comprising:
a male plug comprising a fiber optic encased in a rigid probe;
one of an SC and LC female receptacle formed from injection molded plastic, said receptacle comprising an opening to receive said probe; and
a press fitted sleeve lining an inner wall of said opening to protect said injection molded plastic from direct contact with probe.

17. A SSF pluggable connector as recited in claim 16, wherein said injection molded plastic comprises polyetherimide (PEI).

18. A SSF pluggable connector as recited in claim 16 wherein said press fitted sleeve comprises a generally cylindrical in shape having a C-shaped cross section.

19. A SSF pluggable connector as recited in claim 16 wherein said press fitted sleeve comprises one of a metal and a ceramic.

20. A SSF pluggable connector as recited in claim 16 wherein said press fitted sleeve comprises brass.
